(19) United States
(12) Patent Application Publication
(10) Pub. No.: US 2004/0091091 A1
(43) Pub. Date: May 13, 2004

(54) Charging server, charging method, recorded medium where charging program is stored, and recorded medium where connection program is stored

(76) Inventors: Mikio Maruyama, Tokyo (JP); Shinchiro Tanaka, Shizuoka (JP)

Correspondence Address: EDWARDS & ANGELL, LLP, P.O. BOX 55874, BOSTON, MA, 02205, US

(21) Appl. No.: 10/432,182

(22) PCT Filed: Dec. 22, 2000
(86) PCT No.: PCT/JP00/09132

(30) Foreign Application Priority Data
Nov. 20, 2000 (JP) 2000-352254

(51) Int. Cl. H04M 15/00; H04M 3/42

(52) U.S. Cl. 379/114.13; 379/114.1; 379/201.01

(57) ABSTRACT

A recording medium storing a program for connecting a caller terminal and a recipient terminal that make a call by using a network in which an IP address of a user is assigned when the user connects with the network is provided. The program includes an IP address acquiring module 300 for acquiring an IP address of the caller terminal from a provider in a case where a user of the caller terminal input a call request and an e-mail sending module 304 for creating an e-mail containing information indicating the IP address of the caller terminal and an indication button for instructing a request of the call from the recipient terminal to the caller terminal so as to send the e-mail to the recipient terminal.

### TECHNICAL FIELD

The present invention relates to an accounting server, a charging method, a recording medium storing a charging program and a recording medium storing a connecting program. More particularly, the present invention relates to a recording medium storing a program for connecting a caller terminal to a recipient terminal to which users' IP addresses are respectively assigned when being connected to a network, an accounting server for charging a phone charge, a charging method and a recording program storing a charging program.

The present application relates to Japanese Patent Application No. 2000-352254, filed on Nov. 20, 2000, the contents of which is incorporated herein by reference.

### BACKGROUND ART

In the Internet, an IP address is assigned to each of terminals, thereby the terminals can be identified based on their IP addresses. Japanese Patent Application Laid-Open No. 2000-172611 discloses the invention in which a given videophone apparatus notifies all other videophone apparatuses of its dynamic IP address that is temporarily loaned thereto for connection to the Internet. According to that invention, each videophone apparatus transmits/receives data directly to/from a recipient's video phone apparatus by using the dynamic IP address of the recipient's apparatus. In addition, Japanese Patent Application Laid-Open No. 10-322391 discloses the invention in which a terminal sends its IP address to a recipient via a line other from the Internet. In this case, the recipient who received the sent IP address transmits/receives data directly to/from the terminal of a person who requests communication by performing transmission operation of communication via the Internet by using the IP address received via the line other from the Internet.

However, in a case where the recipient terminal is not connected to the network, information of the person who requests the communication cannot be sent to the recipient by using the Internet.

### DISCLOSURE OF INVENTION

According to the first aspect of the present invention, an accounting server for charging a fee in accordance with a call to at least one of a caller terminal and a recipient terminal that makes the call by using a network in which an IP address of a user is assigned when the user connects with the network, comprises: a calling information receiving unit operable to regularly receive calling information indicating that said terminals are making the call during said call from at least one of said caller terminal and said recipient terminal; a charging unit operable to charge a phone charge to at least one of said caller terminal and said recipient terminal based on said calling information; and an advertisement transmitting unit operable to transmit advertisement information to be displayed on at least one of said caller terminal and said recipient terminal to said at least one terminal, wherein said charging unit reduces said phone charge based on an access to said advertisement information transmitted by said advertisement transmitting unit from a user of said at least one terminal.

The accounting server may further comprise a call-start-request receiving unit operable to receive start-request information indicating that a request of said call was performed from said caller terminal in a case where said caller terminal sent said recipient terminal an e-mail requesting said call, wherein said advertisement transmitting unit starts to transmit said advertisement information to said caller terminal on a condition that said start-request information was received.

The calling information receiving unit may receive from said caller terminal information indicating a start of said call when said call was started, and includes a means operable to stop transmission of said advertisement information when receiving said information indicating the start of said call.

The advertisement transmitting unit may transmit said advertisement information to said caller terminal during said call.

The accounting server may further comprises: an advertisement displaying program holding unit operable to store a program for making a terminal display said advertisement information after an end of said call; and a program transmitting unit operable to transmit said program stored in said advertisement displaying program holding unit to said caller terminal.

The accounting server may further comprises: an advertisement displaying program holding unit operable to store a program for making a terminal display said advertisement information after an end of said call; and a program transmitting unit operable to transmit said program stored in said advertisement displaying program holding unit to said recipient terminal.

The calling information receiving unit may regularly receive said calling information during said call from said caller terminal and said recipient terminal.

The charging unit may charge said phone charge to both said caller terminal and said recipient terminal.

The accounting server may further comprise a calculating program storing unit operable to store a program for calculating a call duration during said call; and a program transmitting unit operable to transmit said program to said caller terminal or said recipient terminal.

The accounting server may further comprise an advertisement-display information receiving unit operable to receive information indicating that said advertisement information has been displayed by said caller terminal or said recipient terminal in a case where said caller terminal or said recipient terminal has displayed said advertisement information, wherein said charging unit reduces at least a part of said phone charge in a case where said advertisement-display information receiving unit received said information.

The advertisement information may contain link information for allowing jump to detail information provided on said network, and the charging unit may reduce at least a part of said phone charge in a case where the jump was made from said advertisement information displayed by said caller terminal or said recipient terminal to said detail information.

The charging unit may charge at least a part of a reduced amount of said phone charge to an advertiser of said advertisement information.

According to the second aspect of the present invention, a recording medium storing a program for charging a fee in accordance with a call to at least one of a caller terminal and a recipient terminal that makes the call by using a network in which an IP address of a user is assigned when said user connects with said network is provided. The program comprises: a calling information receiving module operable to regularly receive calling information indicating that said call is being made from at least one of said caller terminal and said recipient terminal during said call; a charging module operable to charge a phone charge to at least one of said caller terminal and said recipient terminal based on said calling information; an advertisement transmitting module operable to transmit advertisement information to be displayed on at least one of said caller terminal and said recipient terminal to said at least one terminal; and a phone charge discount module operable to reduce said phone charge based on an access to said advertisement information from a user of said at least one terminal.

According to the third aspect of the present invention, a charging method for charging a fee in accordance with a call to at least one of a caller terminal and a recipient terminal that make the call by using a network in which an IP address of a user is assigned when said user connects with said network, comprises: regularly receiving calling information indicating that said call is being made from at least one of said caller terminal and said recipient terminal during said call; charging a phone charge to at least one of said caller terminal and said recipient terminal based on said calling information; and reducing said phone charge based on an access to said advertisement information from a user of said at least one terminal.

According to the fourth aspect of the present invention, a recording medium storing a program for connecting a caller terminal and a recipient terminal that make a call by using a network in which an IP address of a user is assigned when said user connects with said network is provided. The program comprises: an IP address acquiring module operable to acquire an IP address of said caller terminal from a provider in a case where a user of said caller terminal input a request of a call; and an e-mail sending module operable to create an e-mail containing information indicating said IP address of said caller terminal and an indicating button for instructing a request of said call from said recipient terminal to said caller terminal and to send said e-mail to said recipient terminal.

The program may further comprise a receiving module operable to receive advertisement information to be displayed on said caller terminal.

The receiving module may receive said advertisement information until a start of said call.

The receiving module may receive said advertisement information during said call.

The program may further comprise a calling information transmitting module operable to transmit information indicating a start of said call to an accounting server for charging a phone charge when said call was started.

The program may further comprise an advertisement displaying module operable to make said advertisement information be displayed after an end of said call.

The program may further comprise an advertisement displaying module operable to make said advertisement information be displayed during said call.

The program may further comprise an advertisement displaying module operable to make said advertisement information be displayed in said caller terminal before said call.

The program may further comprise a calling information transmitting module operable to regularly transmit calling information indicating that said call is being made to an accounting server for charging a phone charge during said call.

The program may further comprise a call duration calculating module operable to calculate duration of said call during said call.

The program may further comprise a call duration transmitting module operable to a total of said duration of said call calculated by said call duration calculating module to an accounting server for charging a phone charge.

The program may further comprise an advertisement-displaying information transmitting module operable to transmit information indicating that said advertisement information was displayed on said caller terminal to an accounting server for charging a phone charge in a case where said advertisement information was displayed on said caller terminal.

The calling information transmitting module may transmit information indicating an end of said call to said accounting server when said call was finished.

### BRIEF DESCRIPTION OF DRAWINGS

FIG. 1 is a schematic diagram of the entire connection system according to the first embodiment of the present invention.

FIG. 2 is a block diagram showing a functional structure of an accounting server 20.

FIG. 3 is a block diagram showing a hardware configuration of the accounting server 20.

FIG. 4 is a block diagram showing the functional structure of a connection program stored in a caller terminal 30.

FIG. 5 shows a data format of an advertisement information database 226.

FIG. 6 shows a data format of a user database 230.

FIG. 7 shows a data format of an advertisement-provider database 228.

FIG. 8 is a flowchart of an operation of the caller terminal 30 when a user of the caller terminal requested a call.

FIG. 9 is a flow chart of an operation of the caller terminal 30 from the start to end of the call.

FIG. 10 is a flowchart of an operation of the caller terminal 30 after the call has been finished.

FIG. 11 is a flowchart of an operation of the accounting server 20 when performing a charging operation.

FIG. 12 is an exemplary display screen during a process for connecting the caller terminal 30 and a recipient terminal 40.

FIG. 13 shows an exemplary display screen of advertisement information.

FIG. 14 is a block diagram of the functional structure of the accounting server 20 according to the second embodiment of the present invention.

FIG. 15 is a block diagram of the functional structure of the caller terminal 30 according to the second embodiment.

### BEST MODE FOR CARRYING OUT THE INVENTION

The invention will now be described based on the preferred embodiments, which do not intend to limit the scope of the present invention, but exemplify the invention. All of the features and the combinations thereof described in the embodiment are not necessarily essential to the invention.

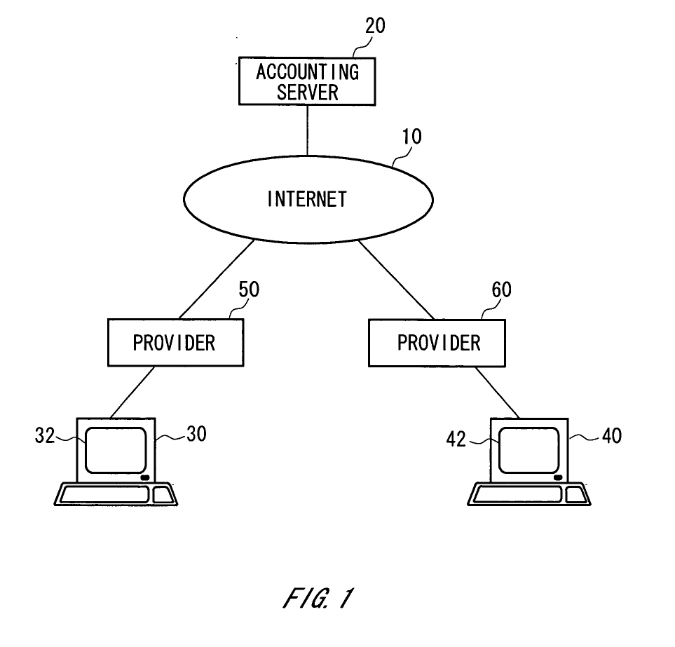

FIG. 1 schematically shows the whole connection system according to the first embodiment of the present invention. A caller terminal 30 connects directly with a recipient terminal 40 by using an IP address of the caller terminal 30. The caller terminal 30 and the recipient terminal 40 are terminals having a function of communication, for example, videophone apparatuses. The caller terminal 30 and the recipient terminal 40 include displays 32 and 42, respectively. A provider 50 is an Internet Service Provider with which a user of the caller terminal 30 signed up. A provider 60 is an Internet Service Provider with which a user of the recipient terminal 40 signed up. The provider 50 assigns the IP address to the caller terminal 30.

The caller terminal 30 transmits an e-mail containing the IP address assigned thereto and a request for communication with the recipient terminal 40 to the provider 60. The recipient terminal 40 connects with the caller terminal 30 by using the IP address combined into the e-mail received from the provider 60. While the caller terminal 30 and the recipient terminal 40 are being connected, the user of the caller terminal 30 and the user of the recipient terminal 40 can make a call by transmitting/receiving audio and image data. The accounting server 20 communicates with the caller terminal 30 and the recipient terminal 40 so as to perform an operation of charging a phone charge. The accounting server 20 also transmits advertisement information to the caller terminal 30 and the recipient terminal 40. Although the accounting server 20 performs the charging operation and transmits the advertisement information in this example, a server other than the server that performs the charging operation may transmit the advertisement information.

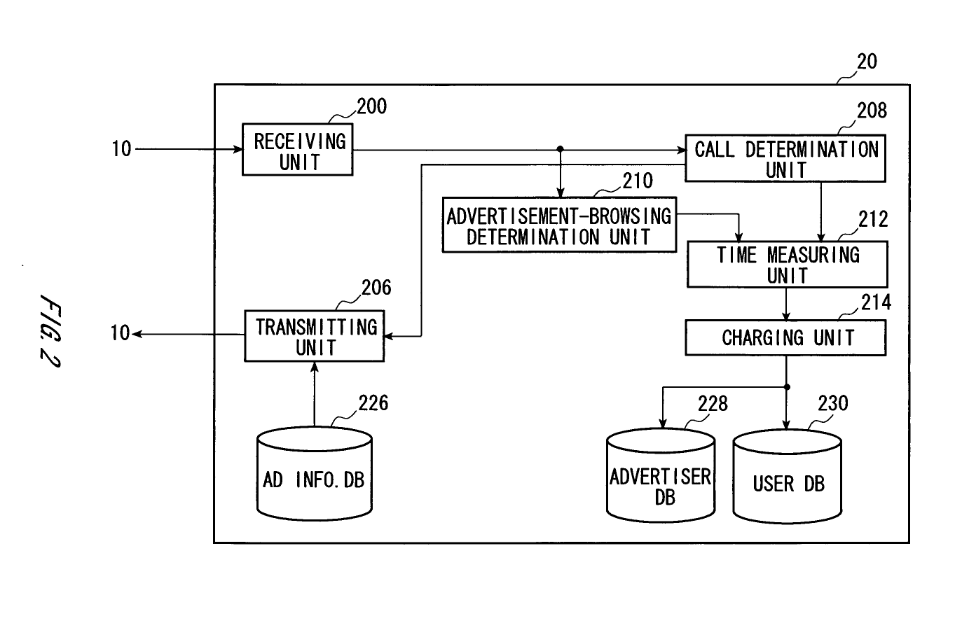

FIG. 2 is a block diagram of the functional structure of the accounting server 20. The accounting server 20 includes a receiving unit 200, a transmitting unit 206, a call determination unit 208, an advertisement-browsing determination unit 210, a time measuring unit 212, a charging unit 214, an advertisement information database 226, an advertiser database 228 and a user database 230. The advertisement information database 226 stores advertisement information therein. The advertiser database 228 stores information about an advertiser therein. The user database 230 stores information about users of the caller terminal 30 and the recipient terminal 40.

The receiving unit 200 receives information indicating that an e-mail containing a request for a call to the recipient terminal 40 was sent to the recipient terminal 40, together with the IP address of the caller terminal 30 from the caller terminal 30.

While the users of the caller terminal 30 and the recipient terminal 40 are on the phone, the receiving unit 200 regularly receives calling information that indicates the users of the terminals 30 and 40 are on the phone from the caller terminal 30 and the recipient terminal 40. The call determination unit 208 sends the calling information received from the receiving unit 200 to the transmitting unit 206 and the time measuring unit 212. The transmitting unit 206 reads out advertisement information from the advertisement information database 226 and transmits it to the caller terminal or the recipient terminal 40. The time measuring unit 212 sends the calling information received from the call determination unit 208 to the charging unit 214. The charging unit 214 calculates phone charge based on the received calling information, and then writes the thus calculated phone charge onto the user database 230.

Moreover, the receiving unit 200 receives from the caller terminal 30 or recipient terminal 40 advertisement-browsing information that indicates the advertisement information is being browsed and sends it to the advertisement-browsing determination unit 210. The advertisement-browsing determination unit 210 sends the time measuring unit 212 the advertisement-browsing information received from the receiving unit 200. The time measuring unit 212 sends the charging unit 214 the advertisement-browsing information received from the advertisement-browsing determination unit 210. The charging unit 214 calculates the amount of discount of the phone charge based on the thus received advertisement-browsing information. Then, the charging unit 214 writes the calculated discount amount onto the user database 230 and further writes it onto the advertiser database 228 so as to charge the calculated discount amount to the advertiser. In the above description, each of the functions of the accounting server 20 was described as one body. However, it is not limited to one body.

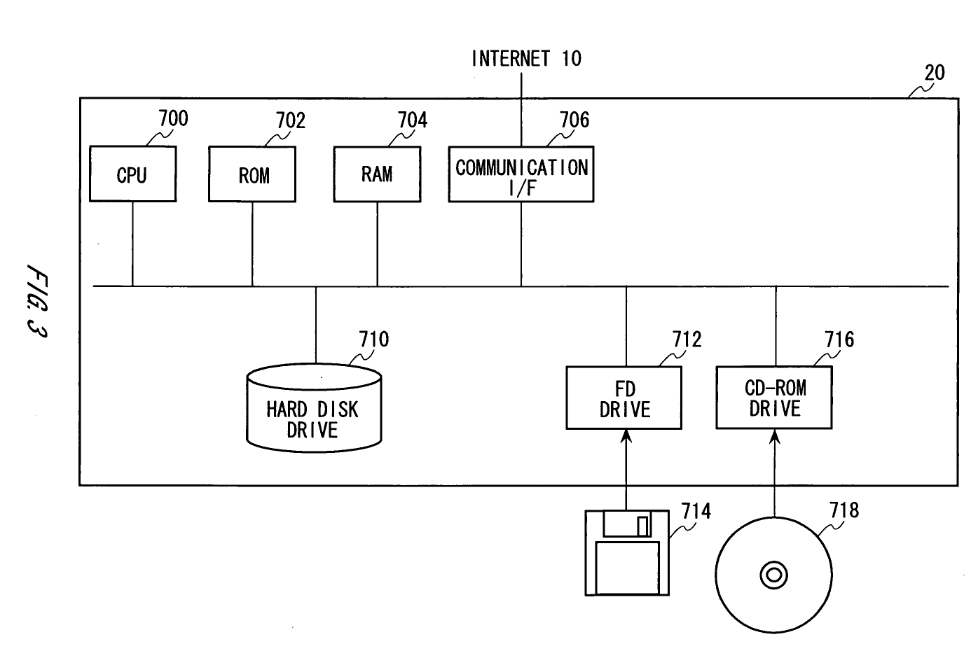

FIG. 3 shows a hardware configuration of the accounting server 20. The accounting server 20 includes a CPU 700, a ROM 702, a RAM 704 and a communication interface 706. The CPU 700 operates based on a program stored in the ROM 702 and RAM 704. The communication interface 706 communicates with the outside of the accounting server 20 via the Internet 10. A hard disk drive 710 as an exemplary storing device stores setting information and a program based on which the CPU 700 operates.

A floppy disk drive 712 reads data or a program from a floppy disk 714 and provides it to the CPU 700. A CD-ROM drive 716 reads data or a program from a CD-ROM 718 and provides it to the CPU 700. The communication interface 706 connects with the Internet 10 to transmit/receive data.

Software executed by the CPU 700 is provided to a user while being stored in a recording medium such as the floppy disk 714 or CD-ROM 718. The software stored in the recording medium may be compressed or non-compressed. The software is installed from the recording medium into the hard disk drive 710 and is then read into the RAM 704 so as to be executed by the CPU 700.

The software that is provided while being stored in the recording medium, that is, software to be installed into the hard disk drive 710 includes as the functional structure a receiving module, a transmitting module, a call determination module, an advertisement browsing determination module, a time measuring module and a charging module. Processes that these modules instruct a computer to execute by means of the CPU 700 are the same as the functions and operations of the corresponding components of the accounting server 20 in the present embodiment and therefore the description thereof is omitted.

It is possible to store a part or all of the operations of the accounting server 20 in all the embodiments described in the present application in the floppy disk 714 or CD-ROM 718 shown in FIG. 3 as an example of the recording medium.

These programs may be read into the RAM directly from the recording medium so as to be executed, or may be read into the RAM so as to be executed after being installed into the hard disk drive. Moreover, the programs may be stored in a single recording medium or a plurality of recording media. In addition, the programs may be stored while being coded.

As the recording medium, other than the floppy disk or CD-ROM, an optical recording medium such as a DVD, a magnetic recording medium such as an MD, an magneto-optical recording medium such as a PD, a tape-like medium, a magnetic recording medium a semiconductor memory such as an IC card or a miniature card and the like can be used. Moreover, a storing device such as a hard disk provided in a server system connected to an exclusive communication network or the Internet or a RAM may be used as the above recording medium so as to provide the program to the accounting server 20 via the communication network. The aforementioned recording medium is used only for manufacturing the accounting server 20 and it is therefore apparent that the manufacture, sale and the like, of this recording medium on business constitute infringement of a patent right based on the present application.

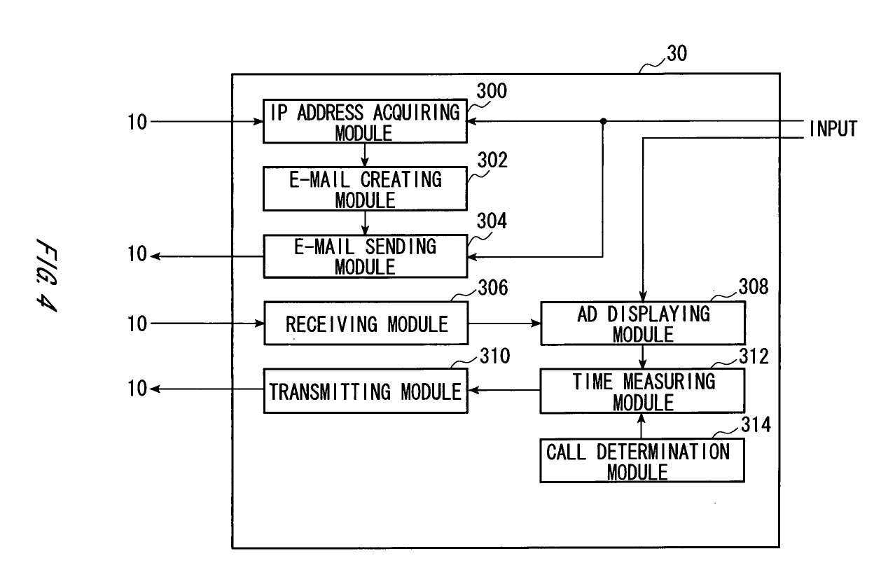

Next, the caller terminal 30 is described. The hardware configuration of the caller terminal 30 is similar to the hardware configuration of the accounting server 20 described referring to FIG. 3 and therefore the description thereof is omitted. FIG. 4 is a block diagram of the functional structure of a connection program stored in the caller terminal 30. The connection program is provided while being stored in a recording medium such as a CD-ROM or floppy disk. The connection program includes an IP address acquiring module 300, an e-mail creating module 302, an e-mail sending module 304, a receiving module 306, an advertisement displaying module 308, a transmitting module 310, a time measuring module 312 and a call determination module 314.

When information indicating a request for a call to the user of the recipient terminal 40 is input together with an e-mail address of the recipient terminal 40 by the user of the caller terminal 30, the IP address acquiring module 300 connects with the provider 60 so as to acquire an IP address of the caller terminal 30. The IP address acquiring module 300 then sends the acquired IP address to the e-mail creating module 302. The e-mail creating module 302 creates an e-mail into which the thus received IP address is combined and sends the created e-mail to the e-mail sending module 304. The e-mail sending module 304 sends the e-mail created by the e-mail creating module 302 to the e-mail address of the recipient terminal 40 input by the user.

The call determination module 314 determines whether or not the user of the caller terminal 30 is calling the user of the recipient terminal 40. The time measuring module 312 receives calling information indicating that the user of the caller terminal 30 is calling the user of the recipient terminal 40 in a case where the user of the caller terminal 30 is calling the user of the recipient terminal 40, from the call determination module 314. The time measuring module 312 sends the transmitting module 310 the calling information every time a predetermined time has passed from a time at which the user started the call. The transmitting module 310 transmits the calling information received from the time measuring module 312 to the accounting server 20 through the Internet 10. The receiving module 306 receives advertisement information from the accounting server 20 and sends it to the advertisement displaying module 308. The advertisement displaying module 308 then makes the display 32 of the caller terminal 30 display the received advertisement information. The hardware configuration of the caller terminal 30 is similar to that of the accounting server 20 in FIG. 3 except that the caller terminal 30 further includes an input unit and the display. Therefore, the description of the structure and functions of similar components of the caller terminal 30 to those of the components of the accounting server 20 is omitted.

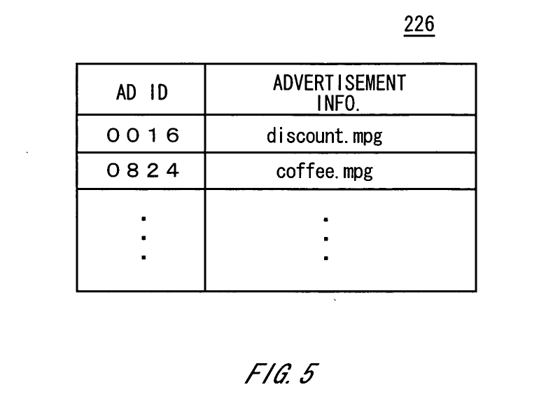

FIG. 5 shows a data format of the advertisement information database 226. The advertisement information database 226 stores advertisement information so as to correspond to an advertisement ID. The advertisement information database 226 has an advertisement ID field and an advertisement information field. The advertisement ID field stores the advertisement ID for identifying the corresponding advertisement information. The advertisement information field stores the advertisement information. It is preferable that the advertisement information be movie information. Moreover, the advertisement information contains link information for jumping to detailed advertisement information. When jump to the detailed advertisement information is instructed by the user while the link information is being displayed on the display 32, the display 32 can display a web page on the Internet on which detailed advertisement information is presented. In this manner, it is possible to suppress the data amount of the advertisement information to be transmitted to the user to a relatively small data amount and to further provide the detailed advertisement information to the user by using the web page.

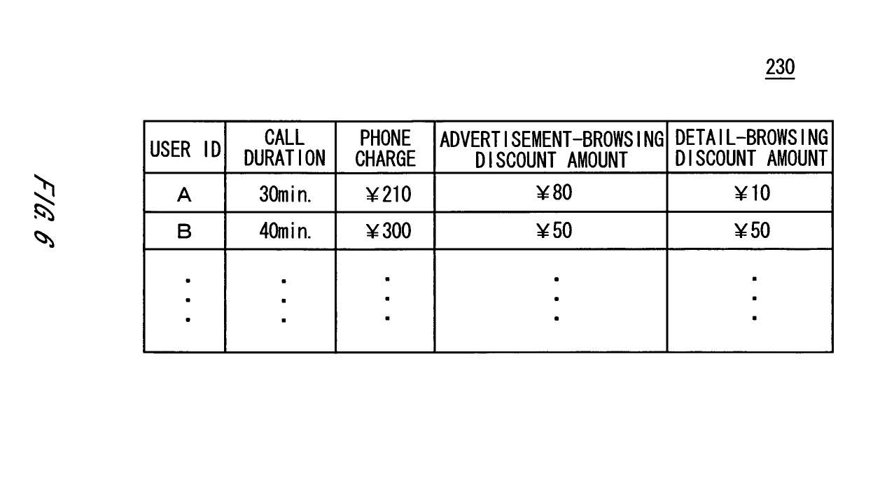

FIG. 6 shows a data format of the user database 230. The user database 230 has a user ID field, a call duration field, a phone charge field, an advertisement-browsing discount amount field and a detail-browsing discount amount field. The user ID field stores a user ID for identifying a user of a caller terminal 30.

The call duration field stores accumulation of durations of calls in which the user was calling. The phone charge field stores accumulation of phone charges. The advertisement-browsing discount amount field stores the discount amount of phone charge based on browsing of the advertisement information. The detail-browsing discount amount field stores the discount amount of the phone charge based on the browsing of the detailed advertisement information. The amount to be charged to the user is obtained by subtracting the amount of advertisement-browsing discount and the amount of detail-browsing discount from the phone charge. Since the user database 230 stores the amount of advertisement-browsing discount, the amount of detail-browsing discount and the phone charge therein, the accounting server 20 can determine the phone charge to each user by using the user database 230. In this manner, since the user database 230 stores for each user the amount of advertisement-browsing discount, the amount of detail-browsing discount and the phone charge, the accounting server 20 can manage the phone charge to every user. When a user browsed an advertisement, the phone charge to that user is reduced based on the browsing time. That is, as longer the user browsed the advertisement, the discount amount increases. Moreover, when the user browsed detailed advertisement information, the phone charge to that user is further reduced based on the browsing time. In an alternative example, a discount rate may be different depending on the contents of advertisements.

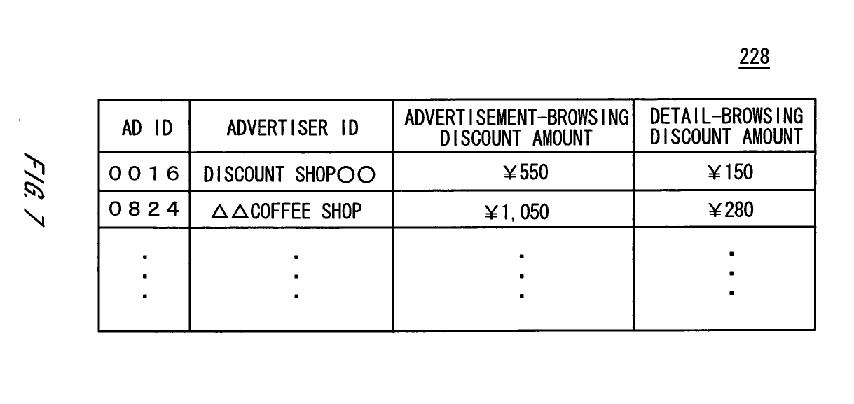

FIG. 7 shows a data format of the advertiser database 228. The advertiser database 228 has an advertisement ID field, an advertisement-browsing amount field and a detail-browsing amount field. The advertisement ID field stores an advertisement ID for identifying the corresponding advertisement information. The advertiser ID stores an advertiser ID for identifying an advertiser of the corresponding advertisement information. The advertisement-browsing discount amount field stores the discount amount based on the duration or the number of times of the browsing of the advertisement information by the users of the caller terminal 30 and recipient terminal 40. Every time the user browsed the advertisement information, the phone charge to that user is reduced in accordance with the duration or the number of times of the browsing by the user. The reduced amount is charged to the advertiser. The advertisement-browsing discount amount field stores the amount charged to the advertiser.

The detail-browsing discount amount field stores the amount of money in accordance with the duration or the number of times of the browsing of the detailed advertisement information by the users of the caller terminal 30 and the recipient terminal 40. Every time the user browsed the detailed advertisement information, the phone charge to that user is reduced in accordance with the duration or the number of times of the browsing. The reduced amount is charged to the advertiser. The detail-browsing discount amount field stores the amount charged to the advertiser.

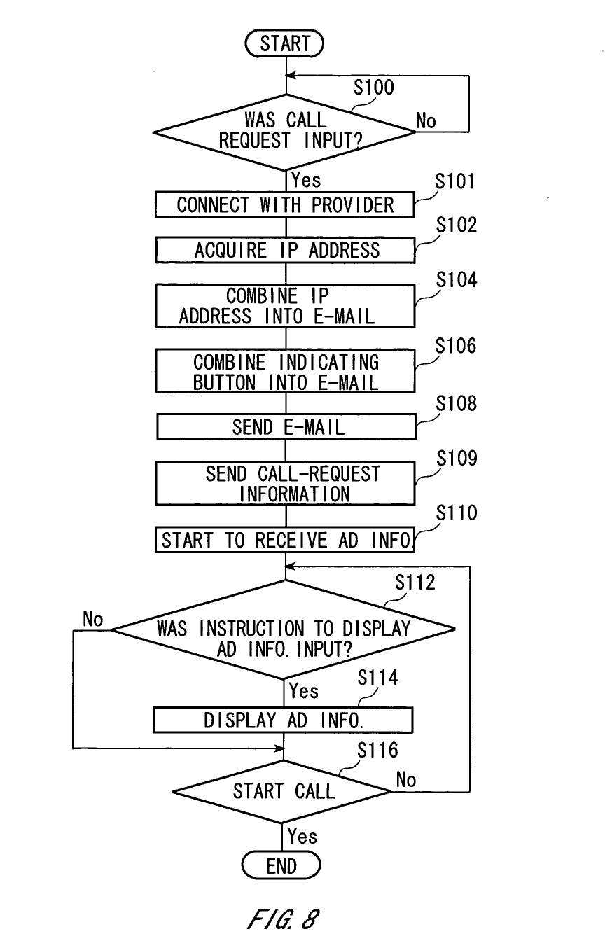

FIG. 8 is a flowchart of an operation of the caller terminal 30 when the user of the caller terminal 30 input a request of a call. In a case where the user of the caller terminal 30 has input a call request together with the e-mail address of the user of the recipient terminal 40 (Step S100), the caller terminal 30 connects with the provider 50 (Step S101). Then, the IP address acquiring module 300 acquires the IP address of the caller terminal 30 from the provider 50 (Step S102). The e-mail creating module 302 creates an e-mail into which the IP address acquired by the IP address acquiring module 300 is combined (Step S104). In this manner, the caller terminal 30 can automatically create the e-mail into which the IP address of the caller terminal 30 is combined. Thus, the caller terminal 30 can notify the recipient terminal 40 of the IP address of the caller terminal 30 by using the created e-mail.

Then, the e-mail creating module 302 further combines an indicating button that makes the recipient terminal 40 indicate whether or not the recipient terminal 40 makes a call, into the e-mail (Step S106). The user of the recipient terminal 40 can indicate whether or not to start the call to the caller terminal 30 by using the indicating button combined into the e-mail received from the caller terminal 30. When the user of the recipient terminal 40 has clicked the indicating button, connection with the caller terminal 30 is established by using the IP address combined into the e-mail. In this manner, the user of the recipient terminal 40 can call the user of the caller terminal 30 only by the simple operation, i.e., by clicking the indicating button combined into the e-mail.

Then, the e-mail sending module 302 sends the recipient terminal 40 the e-mail into which the IP address and indicating button were combined (Step S108). Thee-mail sending module 302 also sends the accounting server 20 information describing that the e-mail indicating the call request was sent to the recipient terminal 40 (Step S109). Then, the accounting server 20 receives from the caller terminal 30 the e-mail indicating the request for the call to the recipient terminal 40 and sends the caller terminal 30 advertisement information on the condition that the e-mail was received. The receiving module 306 starts to receive the advertisement information from the accounting server 20 (Step S110). The caller terminal 30 continues to receive the advertisement information from the accounting server 20 after the start of the call, and also continues to receive it until the display of the advertisement information is stopped after the end of the call.

The advertisement displaying module 308 makes, in a case where the instruction to display the advertisement information was input from the user (Step S112), the display 32 display the advertisement information received by the receiving module 306 (Step S114). Until the receiving module 306 receives information indicating the instruction to start the call from the recipient terminal 40 (Step S116), the display 32 displays the advertisement information. Then, when the user of the recipient terminal 40 has clicked the indicating button in the e-mail received from the caller terminal 30, the call is started (Step S116), thereby finishing the operation of the caller terminal 30 until the start of the call. In this manner, the caller terminal 30 can receive the advertisement information from the accounting server 20 by using a waiting time during which the caller terminal 30 is waiting for the instruction from the recipient terminal 40.

In the present embodiment, the caller terminal 30 continues to receive the advertisement information from the accounting server 20 after the start of the call and also continues to receive it until the display of the advertisement information is stopped, even after the end of the call. However, the receiving of the advertisement information may be stopped on the condition that the call has been started or finished. Moreover, the advertisement information to be received may be related to a single advertisement or a plurality of units of advertisements. In a case of a single advertisement, the receiving of the advertisement information may be stopped when the displaying of the advertisement information corresponding to the advertisement has been finished. Furthermore, in the present embodiment, the caller terminal 30 displays the advertisement information until the start of the call in Step S114. However, in an alternative example, the advertisement information may be displayed during the call.

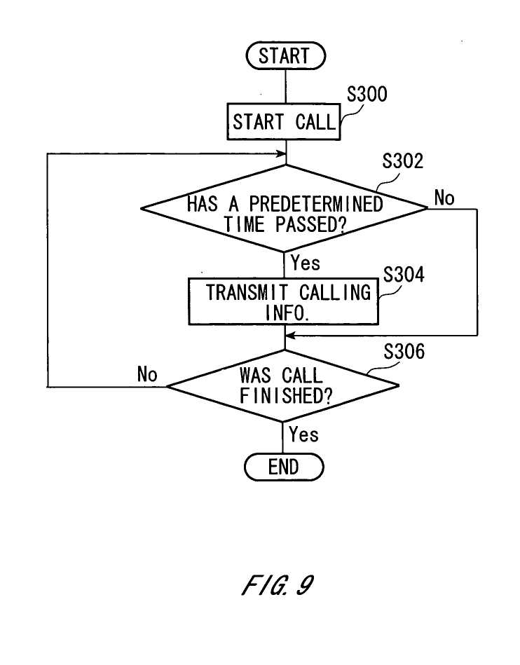

FIG. 9 is a flowchart of an operation of the caller terminal 30 from the start to the end of the call. When the user of the recipient terminal 40 has selected the indicating button combined into the e-mail received from the caller terminal 30, the recipient terminal 40 connects with the caller terminal 30 by using the IP address of the caller terminal 30, thereby starting the call (Step S300). The transmitting module 310 transmits to the accounting server 20 information describing the call was started. In a case where a predetermined time has passed after the start of the call (Step S302), the transmitting module 310 transmits to the accounting server 20 calling information indicating that the caller terminal 30 and the recipient terminal 40 are on the phone (Step S304). Then, in a case where the call determination module 314 did not determine that the call was finished (Step S306), the flow goes to Step S302. Ina case where the call determination unit 314 determined in Step S306 that the call was finished, the transmitting module 310 transmits to the accounting server 20 information describing that the call was finished, thereby the operation of the caller terminal 30 is finished. In this manner, the caller terminal 30 regularly transmits to the accounting server 20 the calling information indicating that the terminals 30 and 40 are calling. Thus, the accounting server 20 can calculate the phone charge based on the duration of the call received from the caller terminal 30 and the recipient terminal 40.

In this manner, the accounting server 20 receives the information indicating the start of the call, the information indicating the end of the call and the calling information from the caller terminal 30 and the recipient terminal 40. Thus, the accounting server 20 can accurately charge the call even if the call was stopped because of a trouble during the call. In this example, the accounting server 20 receives not only the information indicating the start of the call and the information indicating the end of the call but also the calling information. However, the accounting server 20 may receive only the information indicating the start of the call and the information indicating the end of the call, or only the calling information.

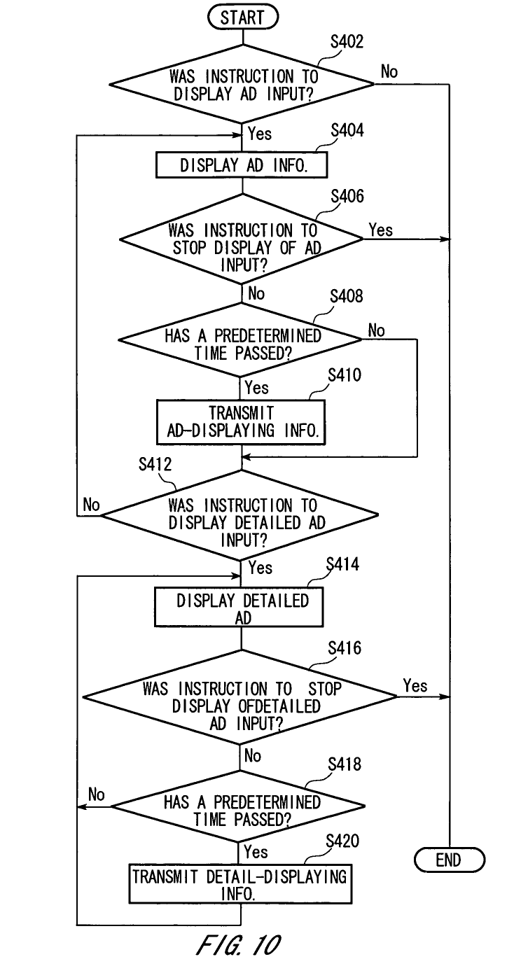

FIG. 10 is a flowchart of an operation of the caller terminal 30 after the end of the call. The advertisement displaying module 308 displays advertisement information (Step S404) in a case where an instruction to display the advertisement information was input from the user (Step S402). In a case where an instruction to stop the display of the advertisement information was not input from the user (Step S406), the time measuring module 312 measures time. When a predetermined time has passed (Step S408), the transmitting module 310 transmits advertisement-displaying information indicating that the predetermined time has passed after the start of the display of the advertisement information, to the accounting server 20 (Step S410). In a case where an instruction to display detailed advertisement information was input from the user (Step S412) the advertisement displaying module 308 displays detailed advertisement information (Step S414). Until the instruction to display the detailed advertisement information has been input in Step S412, the operation from Step S404 to Step S412 is repeated. In a case where an instruction to stop the display of the detailed advertisement information was not input from the user (Step 416), the time measuring module 312 measures time. When a predetermined time has passed (Step S418), the transmitting module 310 transmits detail-displaying information indicating that the predetermined time has passed after the start of the display of the detailed advertisement information to the accounting server 20 (Step S420). Until the instruction to stop the display of the detailed advertisement information is input by the user, the operation from Step S414 to Step S420 is repeated.

In a case where the instruction to display the advertisement information was not input from the user in Step S402, a case where the instruction to stop the display of the advertisement information was input from the user in Step S406, and a case where the instruction to stop the display of the detailed advertisement information was input from the user in Step S416, the operation of the caller terminal 30 is finished.

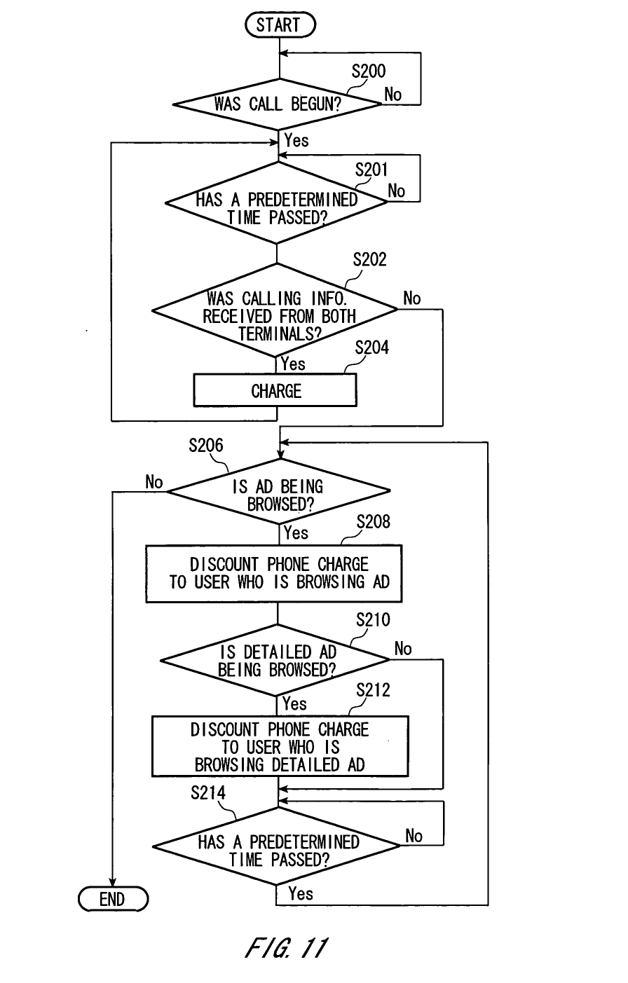

FIG. 11 is a flowchart of an operation of the accounting server 20 when performing a charging operation. In a case where a predetermined time has passed after the users of the caller terminal 30 and the recipient terminal 40 started the call (Step S201), the call determination unit 208 determines whether or not the receiving part 200 received the calling information indicating that the caller terminal 30 and the recipient terminal 40 were on the phone, from both the terminals 30 and 40 (Step S202). In this manner, the accounting server 20 regularly monitors whether or not the caller terminal 30 and the recipient terminal 40 are on the phone. The receiving unit 200 receives the calling information in a case where the caller terminal 30 and the recipient terminal 40 are on the phone. In a case where the receiving unit 200 received the calling information from both the caller terminal 30 and the recipient terminal 40, the charging unit 214 charges the phone charge to the caller terminal 30 (Step S214). While the users of the caller terminal 30 and the recipient terminal 40 are on the phone, the operation from Step S200 to Step S204 is repeated, thereby adds up the phone charge.

Since the caller terminal 30 and the recipient terminal 30 directly connects with each other without the accounting server 20, it is difficult for the accounting server 20 to calculate the charge of the call that was made by the users of the caller terminal 30 and the recipient terminal 40. However, in the present embodiment, the accounting server 20 regularly receives the calling information from both the caller terminal 30 and the recipient terminal 40. Thus, the accounting server 20 can calculate the phone charge easily.

Next, an operation of the accounting server 20 when the call was finished is described. In a case where the receiving unit 200 did not receive the calling information from both the caller terminal 30 and the recipient terminal 40 in Step S202, that is, in a case where the call between the caller terminal 30 and the recipient terminal 40 was finished, the advertisement-browsing determination unit 210 determines whether or not each of the users of the caller terminal 30 and the recipient terminal 40 is browsing the advertisement (Step S206). In a case where the user is being browsing the advertisement, the charging unit 214 discounts the phone charge to the user who is browsing the advertisement (Step S208). On the other hand, in a case where the user does not browse the advertisement, the operation of the accounting server 20 is finished. In this description, the “user” means both the users of the caller terminal 30 and the recipient terminal 40.

Then, the advertisement-browsing determination unit 210 determines whether or not the user is browsing the detailed advertisement information (Step S210). In a case where the user browsed the detailed advertisement information, the charging unit 214 discounts the phone charge to the user (Step S212). On the other hand, in a case where the user did not browse the detailed advertisement information, the flow goes to Step S214. Then, the time measuring unit 212 goes to the process in Step S206 in a case where a predetermined time has passed after the user started to browse the advertisement (Step S214). In this manner, in a case where the receiving unit 200 regularly received information indicating the user is browsing the advertisement information and the detailed advertisement information, the charging unit 214 can discount the phone charge to the user.

In a case where all the advertisement information transmitted by the transmitting unit 206 to the caller terminal 30 and the recipient terminal 40 was not displayed by the displays 32 and 34, the caller terminal 30 and the recipient terminal 40 may store the advertisement information so as to display it in the next call. Moreover, although the accounting server 20 receives the calling information from both the caller terminal 30 and the recipient terminal 40 in Step S202, the accounting server 20 may charge on the condition that is received the calling information from the caller terminal 30 or recipient terminal 40 in an alternative example.

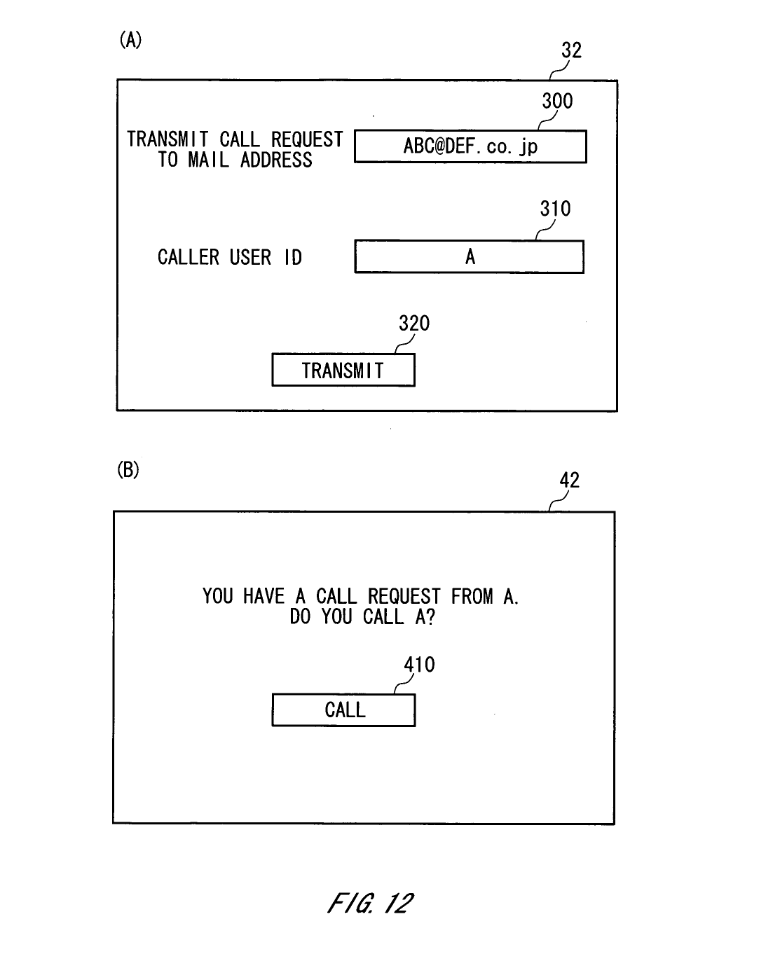

FIG. 12(A) shows an exemplary display screen displayed on the display 32 when the caller terminal 30 transmits a call request to the recipient terminal 40. The user of the caller terminal 30 inputs the mail address of the recipient terminal 40 into a recipient mail address field 300 in accordance with the contents displayed, and also inputs a user ID for identifying the caller terminal 30 into a caller user ID field 310. When the input was completed and the user of the caller terminal 30 has clicked a transmission button 320, the caller terminal 30 automatically creates an e-mail to the mail address input into the recipient mail address field 300 and sends it to the input mail address. In this manner, the user of the caller terminal 30 can transmit the call request to the recipient terminal 40 only by performing simple input.

FIG. 12(B) shows an exemplary e-mail transmitted by the e-mail sending module 304 to the recipient terminal 40. The user of the recipient terminal 40 clicks a call button 410 in a case of calling the caller terminal 30. When the user of the recipient terminal 40 clicked the call button 410, the recipient terminal 40 and the caller terminal 30 are automatically connected by using the IP address of the caller terminal 30 combined into the e-mail. In this manner, the user of the recipient terminal 40 can connect with the caller terminal 30 only by clicking the indicating button. Thus, the user of the recipient terminal 40 can call the user of the caller terminal 30 easily.

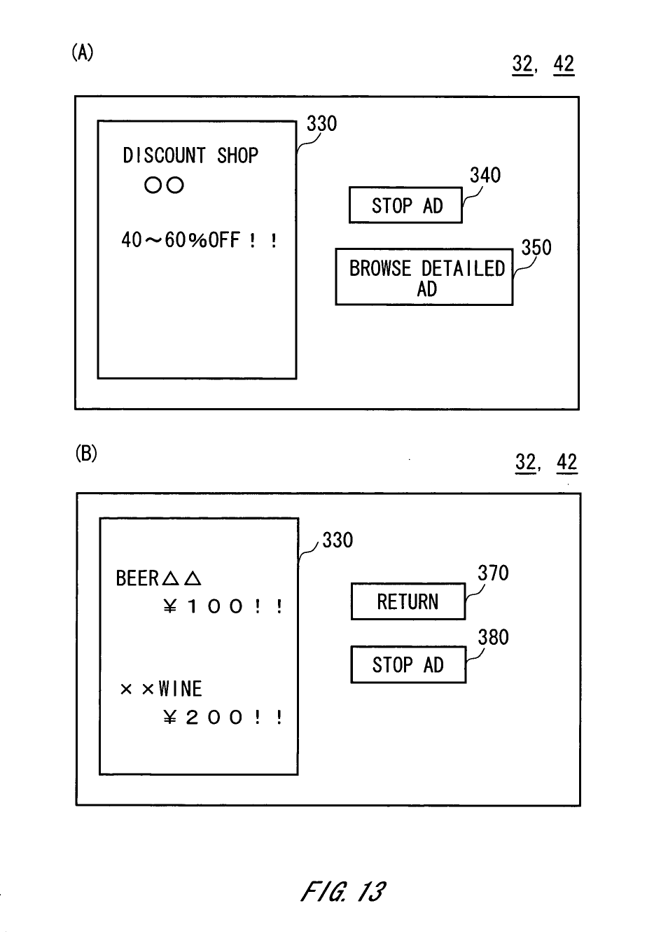

FIG. 13(A) shows an exemplary display screen displayed on the displays 32 and 42 when the advertisement is displayed. When the call between the users of the caller terminal 30 and the recipient terminal 40 was finished and an instruction to browse advertisement information is input in the caller terminal 30 and the recipient terminal 40, the advertisement information is automatically displayed on advertisement displaying units 330 of the displays 32 and 42. While the advertisement information is displayed, the receiving unit 200 regularly receives from the caller terminal 30 or recipient terminal 40 information indicating that the advertisement information is being browsed. When the user has clicked an advertisement stop button 240, the display of the advertisement is stopped. On the other hand, when the user has clicked a button 350 for browsing a detailed advertisement, a screen shown in FIG. 13(B) is presented.

FIG. 13(B) shows an exemplary display screen on the caller terminal 30 and the recipient terminal 40 when detailed advertisement information is displayed. On the advertisement displaying unit 330, the detailed advertisement information displayed on the advertisement displaying unit 330 shown in FIG. 10(A) is displayed. While the detailed advertisement information is displayed, the receiving unit 200 regularly receives from the caller terminal 30 or the recipient terminal 40 information indicating that the detailed advertisement information is being browsed. When the user has clicked a return button 370, the display screen goes back to the screen shown in FIG. 10(A). On the other hand, when the user has clicked an advertisement stop button 380, the display of the detailed advertisement information is stopped.

Next, the second embodiment of the present invention is described. In the first embodiment, the accounting server 20 regularly determines whether or not the caller terminal 30 and the recipient terminal 40 are on the phone so as to calculate the duration of the call. However, in the second embodiment, instead of doing the above, the call duration is acquired by transmitting a program for calculating the call duration to the caller terminal 30 and the recipient terminal 40 and running the program on the terminal-side. Moreover, although the advertisement displaying module 308 in the caller terminal 30 displays the advertisement information in the first embodiment, the accounting server 20 stores an advertisement displaying program for making an advertisement be displayed and transmits this program together with the advertisement information to the caller terminal 30 in the second embodiment.

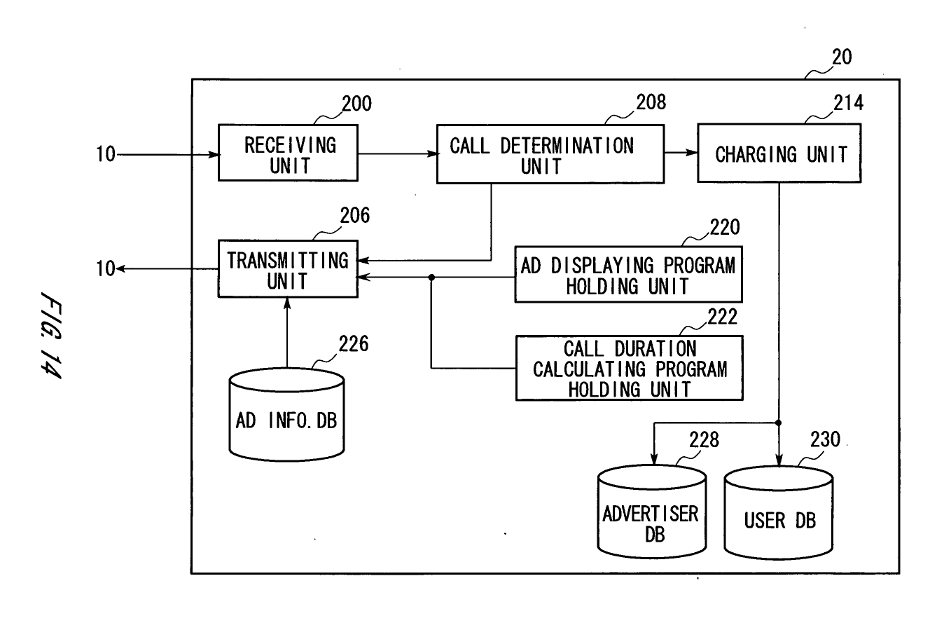

FIG. 14 is a block diagram of the functional structure of the accounting server 20 according to the second embodiment. The accounting server 20 of the present embodiment further includes a call duration calculating program holding unit 222 and an advertisement displaying program holding unit 220. In this respect, the accounting server 20 of the present embodiment is different from that of the first embodiment. Moreover, the accounting server 20 of the present embodiment is different from that of the first embodiment in that it does not include the advertisement-browsing determination unit 210 and the time measuring unit 212. Except for the above, the structure and operation of the accounting server 20 of the present embodiment is similar to those of the accounting server 20 of the first embodiment and therefore the description thereof is omitted.

The call duration calculating program holding unit 222 stores a call duration calculating program for calculating a duration of a call between the caller terminal 30 and the recipient terminal 40. The transmitting unit 206 reads out the call duration calculating program from the call duration calculating program holding unit 222 and transmits it to the caller terminal 30 and the recipient terminal 40. The call duration calculating program is run in the caller terminal 30 or the recipient terminal 40. The call duration calculating program calculates the call duration by cooperating with the call duration calculating module 318, the call determination module 314 and the transmitting module 310 and sends the calculated call duration to the accounting server 20 after the end of the call. The receiving unit 200 receives information describing the call duration from the caller terminal 30 and the recipient terminal 40 after the end of the call. The call determination unit 208 receives the information describing the call duration and sends it to the charging unit 214. In this manner, the accounting server 20 can acquire the call duration only by receiving the call duration calculated by the call duration calculating program from the caller terminal 30 and the recipient terminal 40, without regularly monitoring whether or not the users of the caller terminal 30 and the recipient terminal 40 are calling. The receiving unit 200 may receive the call duration calculated by the call duration calculating program from the caller terminal 30 and the recipient terminal 40 when the next call is made. Moreover, the receiving unit 200 may receive the total of call duration in a certain constant time period every time the constant time has passed from the caller terminal 30 and the recipient terminal 40, whether or not the terminals 30 and 40 are calling. Furthermore, the receiving unit 200 may receive the call duration in a case where the phone charge exceeds the constant amount.

The call duration calculating program may calculate time in which the user browsed the advertisement information and time in which the user browsed the detailed advertisement information. In this case, the receiving unit 200 receives the calculated time from the caller terminal 30 and the recipient terminal 40 after the browsing. The receiving unit 200 may receive the time in which the user browsed the advertisement information and the time in which the user browsed the detailed advertisement information from the caller terminal 30 and the recipient terminal 40 when the next call is made.

The advertisement displaying program holding unit 220 stores an advertisement displaying program. In this description, the advertisement displaying program is a program for making the display unit 32 of the caller terminal 30 or the display unit 42 of the recipient terminal 40 display the advertisement information that was transmitted by the accounting server 20 to the caller terminal 30 and the recipient terminal 40.

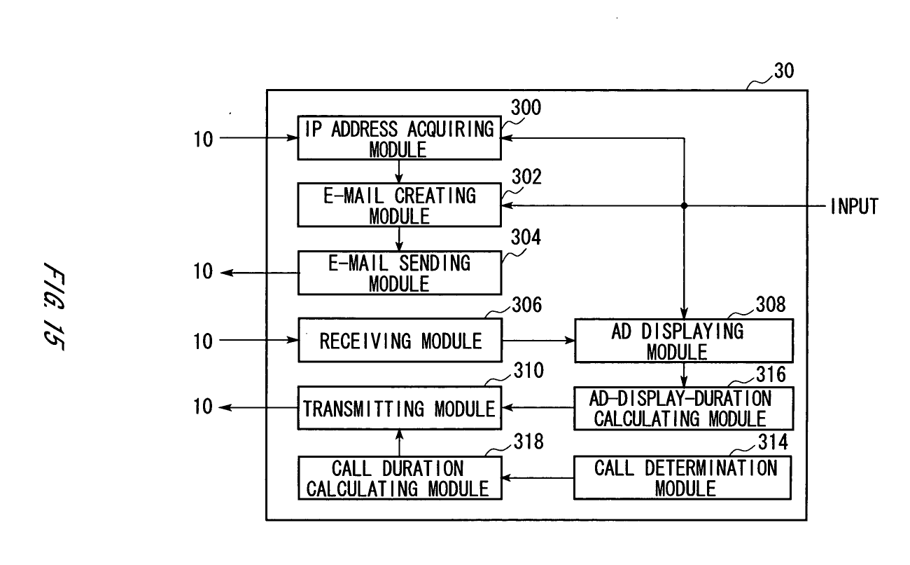

In this manner, in the present embodiment, the call duration calculating program calculates the call duration. Thus, the accounting server 20 of the present embodiment does not require the advertisement-browsing determination unit 210 and the time measuring unit 212 described in the first embodiment. The structure and operation in the present embodiment other than the above are similar to the structure and operation of the accounting server 20 described referring to FIGS. 1-13. A block diagram of the functional structure of the caller terminal 30 in a ca se where the caller terminal 30 received the call duration calculating program and the advertisement displaying program is shown in FIG. 15.

Next, the caller terminal 30 of the second embodiment is described. The hardware configuration of the caller terminal 30 is similar to that of the accounting server 20 described referring to FIG. 3 and therefore the description thereof is omitted. FIG. 15 is a block diagram of the functional structure of a connection program stored in the caller terminal 30 according to the second embodiment. The connection program is provided while being stored in a recording medium such as a CD-ROM or floppy disk.

The caller terminal 30 according to the present embodiment includes the caller terminal 30 of the first embodiment described referring to FIG. 4 and further includes a call duration calculating module 318 and an advertisement-display-duration calculating module 316 but does not include the time measuring module 312. In this respect, the caller terminal 30 of the second embodiment is different from that of the first embodiment. Although the caller terminal 30 or the recipient terminal 40 receives the call duration calculating module 318 and the advertisement-display-duration calculating module 316 from the accounting server 20, the caller terminal 30 or the recipient terminal 40 may include the call duration calculating module 318 and the advertisement-display-duration calculating module 316 in an alternative example. In this case, the caller terminal 30 and the recipient terminal 40 can calculate the call duration without receiving the call duration calculating program.

The call duration calculating module 318 calculates the duration of the call between the caller terminal 30 and the recipient terminal 40 upon receipt of the information that the caller terminal 30 and the recipient terminal 40 are on the phone from the call determination module 314, and sends the call duration to the transmitting module 310. The transmitting module 310 transmits the call duration to the accounting server 20. The advertisement-display-duration calculating module 316 calculates an advertisement-display duration in which the caller terminal 30 and the recipient terminal 40 displayed advertisement information and sends the calculated advertisement-display duration to the transmitting module 310. The transmitting module 310 transmits the advertisement-display duration to the accounting server 20.

In this manner, by calculation of the call duration by the call duration calculating module 318, the accounting server 20 can acquire the call duration without calculating the call duration. Moreover, since the advertisement-display-duration module 316 calculates the display duration of the advertisement information, the accounting server 20 can acquire the display duration of the advertisement displayed on the caller terminal 30 or the recipient terminal 40 without calculating the advertisement-display duration. In this example, the transmitting module 310 may transmit the call duration calculated by the call duration calculating program to the accounting server 20 when the next call is made. Moreover, the transmitting module 310 may transmit the total of the call duration in a certain constant time period to the accounting server 20 every time the constant time period has passed, whether or not the terminals are on the phone. In addition, the transmitting module 310 may transmit the call duration to the accounting server 20 in a case where the phone charge exceeds a predetermined constant amount.

Although the present invention has been described by way of exemplary embodiments, the scope of the present invention is not limited to the above. Many changes and substitutions can be made to the above embodiments. For example, the caller terminal 30 displays an advertisement after the end of a call in the present embodiment. However, the caller terminal 30 may display the advertisement before the call. In this case, the advertisement is displayed from a time immediately after the call request was transmitted by the caller terminal 30 until the user of the recipient terminal 40 clicks the indicating button. Moreover, the caller terminal 30 and the recipient terminal 40 may display the advertisement during the call. It is apparent from the description of the appended claims that such changes or substitutions can be included in the scope of the present invention.

### INDUSTRIAL APPLICABILITY

As is apparent from the above description, it is possible to provide a recording medium storing a program for easily notifying a person with which a person requesting communication wants to communicate of information about the requesting person by using the Internet, and a charging method.

1. An accounting server for charging a fee in accordance with a call to at least one of a caller terminal and a recipient terminal that makes said call by using a network in which an IP address of a user is assigned when the user connects with the network, comprising:
a calling information receiving unit operable to regularly receive calling information indicating that said terminals are making the call during said call from at least one of said caller terminal and said recipient terminal;
a charging unit operable to charge a phone charge to at least one of said caller terminal and said recipient terminal based on said calling information; and
an advertisement transmitting unit operable to transmit advertisement information to be displayed on at least one of said caller terminal and said recipient terminal to said at least one terminal, wherein
said charging unit reduces said phone charge based on an access to said advertisement information transmitted by said advertisement transmitting unit from a user of said at least one terminal.

2. An accounting server as claimed in claim 1, further comprising a call-start-request receiving unit operable to receive start-request information indicating that a request of said call was performed from said caller terminal in a case where said caller terminal sent said recipient terminal an e-mail requesting said call, wherein
said advertisement transmitting unit starts to transmit said advertisement information to said caller terminal on a condition that said start-request information was received.

3. An accounting server as claimed in claim 2, wherein said calling information receiving unit receives from said caller terminal information indicating a start of said call when said call was started, and includes a means operable to stop transmission of said advertisement information when receiving said information indicating the start of said call.

4. An accounting server as claimed in claim 1, wherein said advertisement transmitting unit transmits said advertisement information to said caller terminal during said call.

5. An accounting server as claimed in claim 1, further comprising:
an advertisement displaying program holding unit operable to store a program for making a terminal display said advertisement information after an end of said call; and
a program transmitting unit operable to transmit said program stored in said advertisement displaying program holding unit to said caller terminal.

6. An accounting server as claimed in claim 1, further comprising:
an advertisement displaying program holding unit operable to store a program for making a terminal display said advertisement information after an end of said call; and
a program transmitting unit operable to transmit said program stored in said advertisement displaying program holding unit to said recipient terminal.

7. An accounting server as claimed in claim 1, wherein said calling information receiving unit regularly receives said calling information during said call from said caller terminal and said recipient terminal.

8. An accounting server as claimed in claim 1, wherein said charging unit charges said phone charge to both said caller terminal and said recipient terminal.

9. An accounting server as claimed in claim 1, further comprising a calculating program storing unit operable to store a program for calculating a call duration during said call; and
a program transmitting unit operable to transmit said program to said caller terminal or said recipient terminal.

10. An accounting server as claimed in claim 1, further comprising an advertisement-display information receiving unit operable to receive information indicating that said advertisement information has been displayed by said caller terminal or said recipient terminal in a case where said caller terminal or said recipient terminal has displayed said advertisement information, wherein
said charging unit reduces at least a part of said phone charge in a case where said advertisement-display information receiving unit received said information.

11. An accounting server as claimed in claim 1, wherein said advertisement information contains link information for allowing jump to detail information provided on said network, and
said charging unit reduces at least a part of said phone charge in a case where the jump was made from said advertisement information displayed by said caller terminal or said recipient terminal to said detail information.

12. An accounting server as claimed in claim 1, wherein said charging unit charges at least a part of a reduced amount of said phone charge to an advertiser of said advertisement information.

13. A recording medium storing a program for charging a fee in accordance with a call to at least one of a caller terminal and a recipient terminal that makes said call by using a network in which an IP address of a user is assigned when said user connects with said network, said program comprising:
a calling information receiving module operable to regularly receive calling information indicating that said call is being made from at least one of said caller terminal and said recipient terminal during said call;
a charging module operable to charge a phone charge to at least one of said caller terminal and said recipient terminal based on said calling information;
an advertisement transmitting module operable to transmit advertisement information to be displayed on at least one of said caller terminal and said recipient terminal to said at least one terminal; and
a phone charge discount module operable to reduce said phone charge based on an access to said advertisement information from a user of said at least one terminal.

14. A charging method for charging a fee in accordance with a call to at least one of a caller terminal and a recipient terminal that make said call by using a network in which an IP address of a user is assigned when said user connects with said network, comprising:
regularly receiving calling information indicating that said call is being made from at least one of said caller terminal and said recipient terminal during said call;
charging a phone charge to at least one of said caller terminal and said recipient terminal based on said calling information; and
reducing said phone charge based on an access to said advertisement information from a user of said at least one terminal.

15. A recording medium storing a program for connecting a caller terminal and a recipient terminal that make a call by using a network in which an IP address of a user is assigned when said user connects with said network, said program comprising:
an IP address acquiring module operable to acquire an IP address of said caller terminal from a provider in a case where a user of said caller terminal input a request of a call; and
an e-mail sending module operable to create an e-mail containing information indicating said IP address of said caller terminal and an indicating button for instructing a request of said call from said recipient terminal to said caller terminal and to send said e-mail to said recipient terminal.

16. A recording medium as claimed in claim 15, wherein said program further comprises a receiving module operable to receive advertisement information to be displayed on said caller terminal.

17. A recording medium as claimed in claim 16, wherein said receiving module receives said advertisement information until a start of said call.

18. A recording medium as claimed in claim 16, wherein said receiving module receives said advertisement information during said call.

19. A recording medium as claimed in claim 15, wherein said program further comprises a calling information transmitting module operable to transmit information indicating a start of said call to an accounting server for charging a phone charge when said call was started.

20. A recording medium as claimed in claim 16, wherein said program further comprises an advertisement displaying module operable to make said advertisement information be displayed after an end of said call.

21. A recording medium as claimed in claim 16, wherein said program further comprises an advertisement displaying module operable to make said advertisement information be displayed during said call.

22. A recording medium as claimed in claim 16, wherein said program further comprises an advertisement displaying module operable to make said advertisement information be displayed in said caller terminal before said call.

23. A recording medium as claimed in claim 15, wherein said program further comprises a calling information transmitting module operable to regularly transmit calling information indicating that said call is being made to an accounting server for charging a phone charge during said call.

24. A recording medium as claimed in claim 15, wherein said program further comprises a call duration calculating module operable to calculate a duration of said call during said call.

25. A recording medium as claimed in claim 24, wherein said program further comprises a call duration transmitting module operable to a total of said duration of said call calculated by said call duration calculating module to an accounting server for charging a phone charge.

26. A recording medium as claimed in claim 22, wherein said program further comprises an advertisement-displaying information transmitting module operable to transmit information indicating that said advertisement information was displayed on said caller terminal to an accounting server for charging a phone charge in a case where said advertisement information was displayed on said caller terminal.

27. A recording medium as claimed in claim 19, wherein said calling information transmitting module transmits information indicating an end of said call to said accounting server when said call was finished.
